(19) United States
(12) Patent Application Publication
(10) Pub. No.: US 2006/0057359 A1
(43) Pub. Date: Mar. 16, 2006

(54) Low density light weight filament and fiber

(76) Inventors: Frederick L. Travelute III, Charlotte, NC (US); Glen P. Reese, Charlotte, NC (US); Walter L. Edwards, Harrisburg, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/244,687

(22) Filed: Oct. 5, 2005

Related U.S. Application Data
(63) Continuation-in-part of application No. 11/091,413, filed on Mar. 29, 2005.
Application No. 11/091,413 is a continuation-in-part of application No. 10/813,893, filed on Mar. 31, 2004.

(51) Int. Cl. B32B 5/22

(52) U.S. Cl. 428/317.9; 428/313.5; 428/318.8

(57) ABSTRACT

A lightweight, low density fiber or filament is disclosed. The fiber or filament includes a thermoplastic polymer blend and having more than thirty five percent (35%) functional void fraction in the form of foam-forming cells for reducing the density of the fiber as compared to a solid fiber; at least five void cells per axial cross section for increasing the structural integrity of the fiber as compared to less uniform foams; and a nucleating agent particle composition (such as a fluorocarbon polymer composition) that is chemically inert with respect to the thermoplastic polymer blend, and is present in an amount less than about 10 percent by weight.

This is a continuation-in-part of Ser. No. 11/091,413 filed Mar. 29, 2005, which is a continuation-in-part of Ser. No. 10/813,893 filed Mar. 31, 2004.

### BACKGROUND

The present invention relates to synthetic filaments and fibers and products made from such filaments and fibers and in particular relates to low density light weight thermoplastic filaments and fibers.

Synthetic polymer filaments are used for a wide variety of applications in the textile and related arts. In a number of these applications, the goal is to mimic the performance of natural fibers, particularly cotton, silk and wool, in the performance of the synthetic fiber. Accordingly, items of interest in such technology include the length, shape and chemical composition of the synthetic filaments, their ability to accept dyes and color, and the ease and extent to which they can be textured.

In other applications, however, the synthetic nature of the filaments or fibers are used to develop new or different applications for which natural fibers are less attractive or less efficient. Such factors include the desire to obtain textile properties at relatively low cost when factors such as hand or appearance need not be considered. Many of these include non-woven applications in which the goal is to obtain some of the properties of textile performance such as low density flexibility or fluid absorbency, but in which the appearance or hand of the fabric is of lesser or no concern.

Other applications for synthetic fibers include filling in which the purpose, regardless of the composition or source of the fiber, is to take up space in a low-density manner that provides cushioning or insulation. For example, synthetic fibers can, in some circumstances, take the place of natural down in insulated garments.

In such filling applications, the fibers or filaments are selected on the basis of their light weight in comparison to their volume; i.e., their low density. In turn, the conventional techniques for producing low density fibers or filaments is to produce the filaments as either hollow or foamed. Both techniques, however, have representative problems. Hollow fibers provide a density advantage over solid fibers of the same size (denier), but typically must be limited to a void percentage of no more than about 20-30 percent in order to maintain sufficient structural integrity to be handled in a reasonably normal matter. Alternatively, foamed fibers likewise demonstrate a density advantage over solid fibers of the same size, but are more difficult to form in a manner that produces a filament or fiber that can be handled in normal or reasonably normal fashion.

For example, it is conventionally understood that a single bubble with a size approaching 20% of the fiber diameter will usually cause the filament to break during spinning and drawing processes. Such breakage has been a significant factor in the low commercial use of foamed filaments. See, U.S. Pat. No. 6,007,911, which suggests that fibers that combine foamed and non-foamed portions can address this problem.

Foamed polymers are, in a general sense, well-established in this art, and an exemplary (but not limiting) summary of the structure and production of sophisticated polymer foams is set forth in U.S. Pat. No. 6,051,174. Foamed fibers, however, have been more difficult to successfully produce in versions that are ultimately useful in final applications. For example, some foamed fibers are too brittle for any further handling. Alternatively, for foamed fibers that are drawn, the density advantages were minimal. In considering foamed fibers, there is no theoretical or conceptual lower limit on the cell sizes of the individual cells in the foam. Instead, these limitations tend to be practical and foams that have cells that are too large are disadvantageous because as the size of the cell approaches the size of the filament, breakage during production or drawing or other processes becomes highly likely resulting in an unsuccessful process or an unusable product.

Generally, representative patent disclosures share one or more of the following features: use of a high intrinsic viscosity (greater than about 0.7) polymer; cooler (“cold”) extrusion below about 280° C., low draw down ratio after extrusion (less than 5:1), large, generally spherical, bubbles (average diameter greater than 100 μm), an extrusion process which employs low shear rates (about 100/sec), and conventional, large diameter nucleants e.g. talc.

Nevertheless, the growth in textile applications in which low-density provides significant functional and commercial advantages raises a continued need for more and better low-density structures. Exemplary (but not exclusive) applications include fiber-fill, air-laid nonwoven fabrics (e.g. diaper cores), ultra-filtration, semi-permeable membranes, thermal and acoustic insulation, artificial fluff pulp, fluff pulp replacement, light-scattering, high opacity applications, and floatation devices.

Therefore, a need continues to exist for improvements in low density fiber structure and the method s for producing them.

### SUMMARY OF THE INVENTION

In one aspect, the invention is a lightweight, low density fiber or filament comprising a thermoplastic polymer blend and having more than thirty five percent (35%) functional void fraction in the form of foam-forming cells for reducing the density of the fiber as compared to a solid fiber; at least five void cells per axial cross section for increasing the structural integrity of the fiber as compared to less uniform foams; and a nucleating agent particle composition (such as a fluorocarbon polymer composition) that is chemically inert with respect to the thermoplastic polymer blend, and is present in an amount less than about 10 percent by weight.

In another aspect, the invention is a method of producing a foamed fiber in a continuous technique. In this aspect the invention comprises mixing an inert nucleating agent with a thermoplastic polymer blend in an amount sufficient to increase the number of cells that the blowing agent will generate as compared to blowing agent alone under the same conditions, but less than an amount that negatively affects the spinning process; dissolving an inert blowing agent in an amount sufficient to generate at least about 35% void fraction in resulting spun filaments in its liquid state into the molten polymer blend to form a solution of the blowing agent in the polymer blend; forwarding the mixture in an extruder to a spinneret at a higher than normal thermoplastic polymer extrusion pressure to give extra shear and encourage expansion of the blowing agent as the filaments leave the spinneret; and spinning the mixture into filaments through the spinneret.

In yet another aspect, the invention is a low density light weight fiber comprising a thermoplastic polymer blend for providing greater elasticity; a hollow core for reducing the overall density of the fiber compared to a solid fiber; and a foamed sheath for further reducing the overall density as compared to a solid-sheath hollow fiber.

The foregoing and other objects and advantages of the invention and the manner in which the same are accomplished will become clearer based on the followed detailed description taken in conjunction with the accompanying drawings.

### BRIEF DESCRIPTION OF THE DRAWINGS

FIGS. 1-6, 8-9, 11, 13, 15, 17 and 19 are scanning electron microscope (SEM) images of fibers and filaments according to the present invention taken longitudinally or in cross section.

FIGS. 7, 10, 12, 14, 16, 18, 20 and 21 are micro photographs of fibers and filaments according to the present invention taken longitudinally or in cross section.

FIGS. 22A, 22B, 23A, 23B, 24A, 24B, 25A, 25B, 26A, 26B, 27A, and 27B are SEM photographs of polytetrafluoroethylene particle compositions.

### DETAILED DESCRIPTION

Unless otherwise indicated herein, the terminology used herein is consistent with that normally used in this art with sources such as Tortora, Fairchild's Dictionary of Textiles, 7^{th} Ed (1996), Capital Cities Media, Inc.; and Lewis, Hawley's Condensed Chemical Dictionary, 12^{th} Ed (1993), Van Nostrand Reinhold, being useful and exemplary for defining any particular terms herein.

The present invention is a lightweight, low density fiber (including filaments) comprising a thermoplastic polymer. The fiber includes more than 35% functional void fraction in the form of foam-forming cells for reducing the density of the fiber as compared to a solid fiber.

In contrast to conventional foams, the present invention incorporates one or more of the following aspects: lower intrinsic viscosity polymers (less than about 0.7), higher extrusion temperatures (up to 300-310° C.), post-extrusion draw-down at greater than about 100:1, high length-to-diameter (L/D) voids with average diameters of less than about 10 μm, extrusion shear rates greater than about 1000/sec, and PTFE nanoparticle nucleants, which create a higher density of smaller bubbles.

Although the number of cells or the percentage of void fraction in the fiber is to some extent (at least at lower void volumes) the choice of the user, the present invention offers the opportunity to have void fractions of between about 35 and 75%. In a number of the prior art foamed fibers, obtaining a void fraction of 35 to 50% or greater has historically been difficult or impossible because the usual course is to generate larger bubbles which, as noted in the background, tend to cause severe mechanical problems in the resulting fibers, the most severe of which is breaking of the filament during the spinning process. In the present invention, obtaining a void fraction of 40% is entirely feasible, while a full weight fraction of 75% appears to be a present reasonable upper limit.

Suitable thermoplastic polymers contemplated as useful in the present invention include polyesters, polylactides, polyamides, polycarbonates, polyolefins, polyacrylics, and combinations thereof. Thermoplastic polymers utilized in the present invention may be copolymers, blockcopolymers, linear, branched, cross-linked, non-crosslinked, and combinations thereof.

In preferred embodiments, the polyester copolymer is a copolymer of polyester and polyethylene glycol with the polyethylene glycol being present in an amount of between about six and 10% by weight. The polyethylene glycol adds a number of favorable properties to the copolymer and these are discussed in a number of commonly assigned issued patents, the contents of which are incorporated entirely herein by reference. These include the following: U.S. Pat. Nos. 6,214,270; 6,291,066; 6,294,254; 6,303,739; 6,322,886; 6,399,705; 6,454,982; 6,485,829; 6,509,091; 6,582,817; and 6,623,853.

The presence of the polyethylene glycol (and in some cases a branching agent such as pentaerythritol) offers some additional process advantages that result in structural advantages and these will be described with respect to the method aspects of the invention.

It has now been discovered that the present foamed fibers may be formed using a blend, (i.e., mixture), of at least one thermoplastic polymer and one additional component. For example, additional components that may be blended with the at least one thermoplastic polymer may include one or more of homopolymers, copolymers, comonomers, and plasticizers. In an exemplary embodiment, a polyethylene terephthalate may be blended with an additional homopolymer, copolymer, comonomer, plasticizer, and combinations thereof. It may be preferred to blend a thermoplastic polymer with between about two and ten percent of one or more of the additional homopolymer, comonomer, copolymer, plasticizer.

Without being bound by theory, it is believed that the use of a polymer blend increases the free volume of the polymer composition. As is known to persons having ordinary skill in the art, polyester is a linear polymer that packs closely together. Blending a second component (such as those discussed above) into a polyester composition may serve to increase the free volume of the composition, thereby increasing the extensibility and elasticity of the polyester. This increase in extensibility and elasticity of the polymer composition increases the relaxation time of the polymers, thereby aiding in the formation of the present foamed fibers.

As known by persons having ordinary skill in the art, a blend of polymers can be distinguished from a homopolymer or copolymer based upon observed glass transition temperatures (T_{g}) and melt points. For example, in most circumstances a copolymer will have a single T_{g} and a single melt point. By comparison, in most circumstances a polymer blend will have a distinct T_{g} and melt point for each component, such as those discussed above.

It is advantageous to have fibers or thin films with a fine cell structure, i.e., the cells are small in relation to the dimensions of the product. Without being bound by theory, it is believed that smaller cell structures may also permit the production of extrusions with more complex geometries such as hollow or non-round fiber cross-sections.

The fiber according to the invention includes at least five cells per axial cross-section for increasing the structural integrity of the fiber as compared to less uniform foams. In preferred embodiments, the fiber will have between about six and 30 cells per cross section. As recognized by those familiar with foamed polymers and related materials, one advantage of a larger number of cells is the greater uniformity provided in the finished foam based upon the smaller size of each individual cell and the greater number of cells per unit volume of the polymer. It will be understood, of course, that 30 cells per cross section is not necessarily a functional upper limit, but that as the average cell size becomes extremely small, the void fraction can actually decrease or the foam-related properties can be less evident as the characteristics of the fiber become more like a solid than a foam.

The fiber according to the present invention also contains an inert nucleating agent present in an amount less than 10% by weight, preferably 2% or less by weight, and most preferably between about 0.5 and 1% by weight. As used herein, the term “inert” means that the nucleating agent is chemically inert with respect to the copolymer, the blowing agent, any other materials in the polymer, and the desired or necessary equipment. The nucleating agents preferably have low wettability with respect to the thermoplastic melt and have micro-crevices on the partial surface that can harbor trapped gases, thereby aiding the nucleation process. Presently preferred nucleating agents include particles of silicone or of fluorocarbon polymer. The advantages of the fluorocarbon polymer particles are best understood in terms of the method aspects of the invention as will be described further herein. In preferred embodiments, the fluorocarbon particles comprise polytetrafluoroethylene, and are available as a powdered lubricant (e.g. NANOFLON from Shamrock Technologies, Newark N.J.; or ZONYL from DuPont) or in related forms.

As is known to persons having ordinary skill in the art, particles of polytetrafluoroethylene (PTFE) are often prepared by one of two methods. One method includes polymerizing PTFE to low molecular weights, then grinding down the particles into smaller sizes. Another method involves irradiating high molecular weight PTFE with an electron beam to break the polymer bonds thereby fragmenting the polymer into smaller portions. The irradiated PTFE can then be ground into small particle sizes. PTFE particles formed according to the irradiation method often include acid groups on the surface of the particles, because the irradiation step is most often conducted in ambient air, resulting in oxidation of the particle surface. Without being bound by theory, it appears that the presence of acid groups on the surface of the PTFE particles results in higher surface energy. The higher surface energy particles appear to have a higher “wettability” in the polymer (homopolymer, copolymer, or blend) than the particles formed by grinding low molecular weight PTFE because the polar acid groups on the surface of the particles may interact with the polymer composition. Accordingly, it appears that “ground” particles perform better than irradiated PTFE particles because of the ground particles' lower surface energy and lower wettability.

These two methods of preparing PTFE particles also tend to result in a PTFE composition having a range of particle sizes (as measured by diameter of the individual particles). In exemplary embodiments, preferred nucleating agent particles are individual particles, rather than agglomerations of smaller particles. More particularly, exemplary PTFE compositions have a particle size distribution wherein about 90% of the particles have a diameter of less than about 20 μm. Stated differently, exemplary PTFE compositions include 80% of particles between about 3 and 20 μm.

Tables 1 and 2 summarize various commercially available PTFE particle compositions. Table 1 sets forth the general information regarding the partcle compositions as provided by the various manufacturers. Table 2 sets forth the particle size distribution of the PTFE compositions described in Table 1 as determined by laser light scattering after dispersion in a light mineral oil and sonication to break up large agglomerates prior to analysis.

TABLE 1

| | | | Surface Area | Avg. Diameter |
|---|---|---|---|---|
| Tradename | Vendor | Processing | (BET, m²/g) | (microns) |
| Nanoflon | Shamrock | irradiated | 8.7 | 13.3 |
| P51A | Technologies | | | |
| Nanoflon | Shamrock | irradiated | 9.9 | 8.3 |
| FluoroFG | Technologies | | | |
| PA5951 | Dyneon, | not | 10 | 10.6 |
| | LLC | irradiated | | |
| PA5955 | Dyneon, | not | 17 | 9.6 |
| | LLC | irradiated | | |
| Zonyl | DuPont | irradiated | 4.5 | 9.3 |
| MP1400 | | | | |
| Zonyl | DuPont | not | 10 | 8.6 |
| MP1600 | | irradiated | | |

TABLE 2

| | Particle Diameter (microns) | | | | | |
|---|---|---|---|---|---|---|
| PTFE ID: | MP1400 | MP1600 | PA5951 | PA5955 | FluoroFG | P51A |
| Avg. (by | 9.3 | 8.6 | 10.6 | 9.6 | 8.3 | 13.3 |
| wt/vol): | | | | | | |
| 10% less | 3.2 | 3.8 | 5.0 | 4.2 | 2.4 | 4.0 |
| than: | | | | | | |
| 50% less | 8.1 | 7.7 | 9.6 | 8.6 | 6.6 | 11.8 |
| than: | | | | | | |
| 90% less | 16.6 | 14.9 | 17.7 | 16.5 | 15.4 | 24.9 |
| than: | | | | | | |
| Breadth | 1.67 | 1.45 | 1.32 | 1.43 | 1.96 | 1.77 |
| of Dis- | | | | | | |
| tribution: | | | | | | |

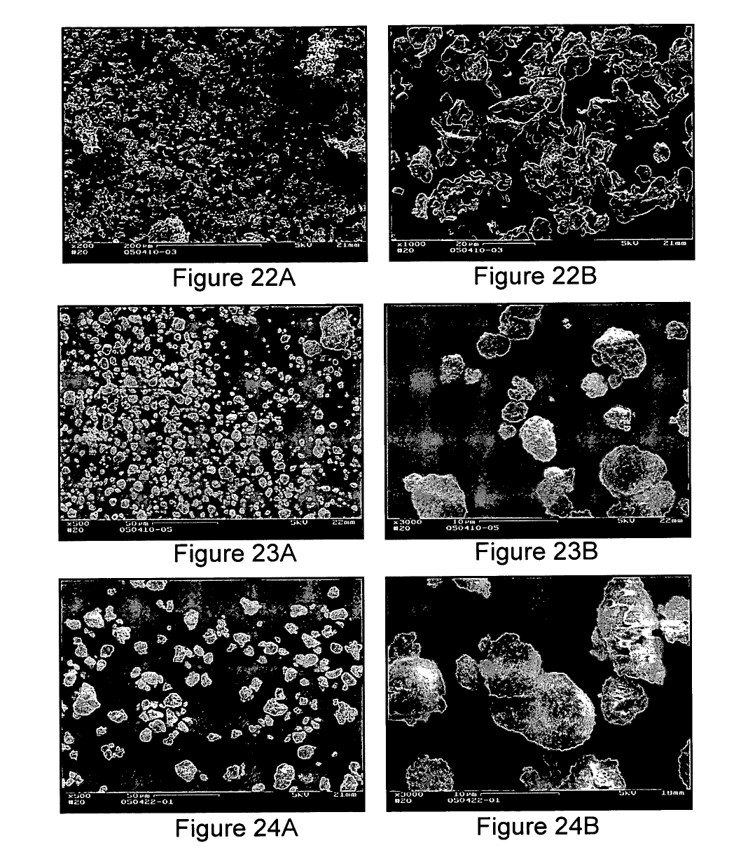

Scanning electron microscopy (SEM) pictures of the PTFE particle compositions show the particle size distributions reflected in Table 2. FIGS. 22A and B depict two SEM photographs of the MP 1400 PTFE particles. FIG. 22A depicts the particles at a magnification of 200 and FIG. 22B depicts the particles at a magnification of 1000. As can be seen in FIGS. 22A and B, MP1400 does not show a spherical morphology, instead showing irregular and somewhat elongated, globular particle shapes.

FIGS. 23A and 23B depict SEM photographs of the MP1600 PTFE composition. FIG. 23A depicts the particles at a magnification of 500 and FIG. 23B depicts the particles at a magnification of 3000. As can be seen, the particle morphology is of substantially spherical, compact particles that do not appear friable (i.e., capable of being broken down into smaller sizes).

FIGS. 24A and B depict SEM photographs of the PA5951 PTFE composition. FIG. 24A depicts the particles at a magnification of 500 and FIG. 24B depicts the particles at a magnification of 3000. As with the particles depicted in FIGS. 23A and B, the particle morphology depicted in FIGS. 24A and B is of substantially spherical, compact particles that do not appear to be friable.

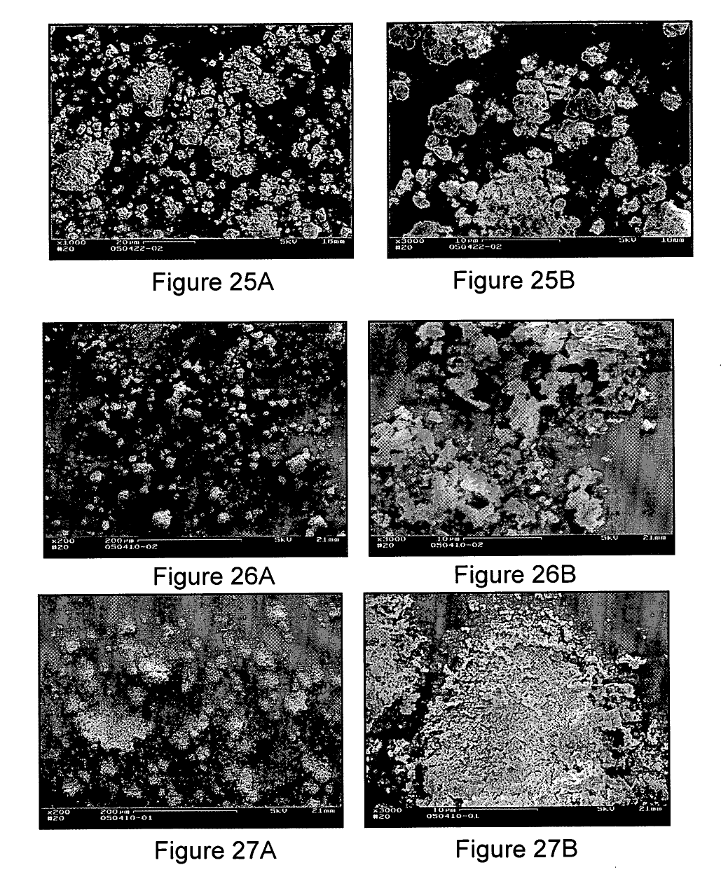

FIGS. 25A and B depict SEM photographs of the PA5955 PTFE composition. FIG. 25A depicts the particles at a magnification of 1000 and FIG. 25B depicts the particles at a magnification of 3000. As can be seen the PA5955 particle composition shows a higher tendency for breakdown of the particles into smaller sizes than can be seen in FIGS. 23 and 24.

FIGS. 26A and B depict SEM photographs of the FlurorFG PTFE composition. FIG. 26A depicts the particles at a magnification of 200 and FIG. 26B depicts the particles at a magnification of 3000. As can be seen, the FluroFG particle composition shows a higher tendency from breakdown of the particles into smaller sizes.

FIGS. 27A and B depict SEM photographs of the Nanoflon P51A PTFE particle composition. FIG. 27A depicts the particles at a magnification of 200 and FIG. 27B depicts the particles at a magnification of 3000. The Nanoflon P51A particles demonstrate a tendency towards agglomeration of small particles rather than the preferred disassociation of particles discussed above.

Accordingly, and without being bound by theory, it appears that PTFE particles having a spherical morphology and a size of between about 5 and 20 μm are exemplary particles for use in preparing the present foamed fibers.

Based on the foam structure, the fiber according to the present invention will have a density of between about 0.4 and 0.9 grams per cubic centimeter (g/cm³) with a density of between about 0.65 and 0.75 g/cm³ most preferred.

Depending upon some of the method techniques set forth herein, the foamed fiber according to the invention can be produced with a smooth surface, with a fibrillated surface, a channeled surface, or a pitted surface. Each of these offers particular advantages and can be controlled using certain of the method aspects of the invention as will be discussed later herein.

Smooth surface fibers are externally most similar to solid fibers and thus offer the advantage of being more easily handled in conventional equipment.

Fibrillated fiber surfaces offer several mechanical and physical advantages. Because the size of the individual fibrils is extremely small; i.e. an order of magnitude smaller then the fiber itself, they offer advantages in moisture absorption and take up because of their capillary effect, while their extremely small size makes than an excellent candidate material for ultra filtration applications. As used herein, the term “fibrillated” refers to small fiber-like (i.e., length much longer than diameter) portions that extend from the “main” fiber, but are typically quite smaller; e.g., an order of magnitude or more. For example, FIG. 6 illustrates several filaments according to the invention that are on the order of 67 microns (μm) in diameter with fibrils (appearing as thin, longitudinal darker or lighter portions) that are on the order of about 5 μm.

A channeled surface offers similar advantages in both moisture absorption and take up. It will be understood that these are different, though related properties. Absorption typically refers to the amount of liquid that a given material can hold under the application of a defined weight. Take up refers to the rate at which a given amount of liquid will be absorbed into a structure. In many circumstances, such as diapers and related absorbent items, both of these properties are desirably maximized and the channel surfaces of the fibers according to the invention provide advantages in both characteristics as compared to solid fibers or conventional foamed or hollow fibers.

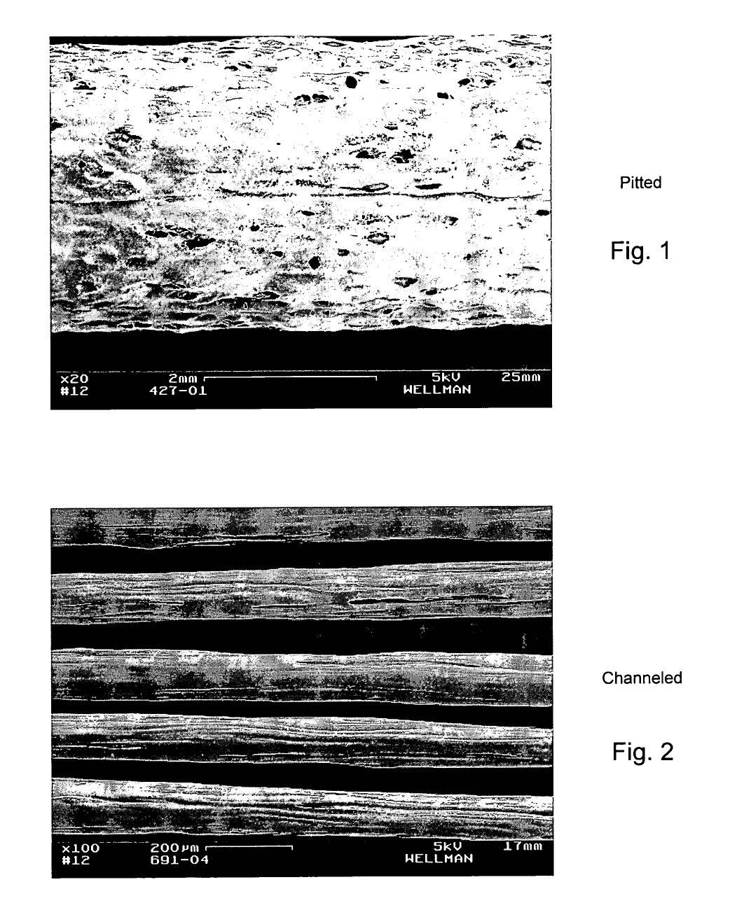

FIG. 2 illustrates such a channeled surface, and shows that filaments on the order of 100-110 μm in diameter can include channels on the order of 9-10 μm in width.

A pitted surface offers some related advantages as well as some particular ones. Related advantages include take-up and absorption of liquids. Particular advantages include a higher liquid retention capacity than fibrillated or channeled-surface fibers, and a surface structure that provides a moderate abrasive function in appropriate or desired applications.

Accordingly, the invention likewise includes fabrics formed with or from the various fibers according to the present invention. It will be understood that in some circumstances fibers according to the present invention will be the only fibers present in such a fabric while another circumstances, fibers according to the invention will provide some, but not all, of the fibers in a particular fabric or structure. For example, Co-pending and commonly assigned U.S. application Ser. No. 10/250,191, filed Jun. 11, 2003, describes an absorbent core structure which is formed of a plurality of elements, each of which serves a particular purpose. In such a structure, the fibers according to the present invention are candidate materials to replace elements such as fluff pulp, but not the bicomponent fibers that typically serve an adhesive function.

The nature of the fibers herein and their properties is such that they are expected to have wide usage in nonwoven fabrics, but the invention is not so limited, and fabrics formed from the fibers of the invention can be selected from the group consisting of woven fabrics, knitted fabrics, filling materials and battings, absorbent cores, direct melt spun fabrics, and nonwoven fabrics. Additionally, fibers formed in accordance with the present invention may be used in product applications including textiles, filtration, insulation, and printable films.

In another aspect, the invention comprises a low density, light weight fiber formed of a thermoplastic polymer that has a high degree of elasticity; more than five cells per axial cross section for increasing the uniformity of the foam and the structural integrity of the fiber; between about 40 and 75% by volume of void space for reducing the density of the fiber; and a non-uniform (multiform, diverse, diversiform) surface for providing additional mechanical properties to the foamed fiber as compared to corresponding smooth surface fiber.

In preferred embodiments, the fiber comprises between about six and 30 cells per axial cross section, although, as noted above, 30 does not represent a functional upper limit.

In preferred embodiments, the nonuniform surface is fibrillated, channelled, or pitted, each of which has the advantages noted above.

As in the previous embodiment, a preferred thermoplastic polymer is formed of polyester and polyethylene glycol with the polyethylene glycol being present in an amount of between about six and 10% by weight.

The fiber can be incorporated into fabrics with such fabrics typically including woven fabrics, filling materials and battings, absorbent cores, direct melt spun fabrics, nonwoven fabrics, and knitted fabrics.

In yet another aspect, the invention can comprise a self-crimping filament. The self crimping filament according to the invention comprises a polyester copolymer, at least about 40% void space by volume, more than five cells per axial cross section, and different (i.e., greater and lesser) degrees of orientation along at least two adjacent longitudinal portions of the filament.

The term orientation is used herein in its usual sense in the polymer arts, i.e. to describe “the degree to which linear polymeric chains are parallel and oriented in a preferred direction in a fiber,” Tortora, Fairchild's Dictionary of Textiles, 7^{th} Ed. (1996), Capital Cities Media., Inc.

As set forth with respect to the method embodiments further herein, the incorporation of different degrees of orientation is typically accomplished at a quenching step, although any process that forms the orientation difference is appropriate provided that it does not otherwise adversely affect the other method steps or the properties of the foamed filament. In that regard, the quenching steps described herein are most preferred.

The manner in which the filament will self crimp is described in commonly assigned U.S. Pat. No. 5,407,625 the contents of which are incorporated entirely herein by reference.

In this embodiment, the fiber can include the preferred aspects of the previously described embodiments including the presence of between about 45 and 75% void space by volume, the use of a thermoplastic polymer, the presence of between about six and 30 cells per axial cross section, the presence of the submicron sized solid particles of a fluorocarbon polymer in an amount not exceeding about 2% by weight, a denier of between about two and 15, and a density of between about 0.4 and 0.6 g/cm³.

In yet another embodiment, the invention comprises a low density light weight fiber comprising a thermoplastic polymer, a hollow core for reducing the overall density of the fiber as compared to a solid fiber; and a foamed sheath for further reducing the overall density as compared to a solid-sheath hollow fiber.

This embodiment has been found to be particularly useful in that the inclusion of a blowing agent to produce the foam also provides an extra degree of expansion to the hollow core that is unavailable when the hollow filament is formed with a solid sheath in the absence of a blowing agent. Stated differently, conventional hollow fiber is typically formed by extruding adjacent and parallel C-shaped sections of filament that join immediately following extrusion from the spinneret and are quenched to form the resulting hollow fiber. In the present invention, however, because the hollow fiber is made in conjunction with the foamed sheath, the blowing agent used to form the foamed sheath also helps expand the hollow core to a greater degree than is typically possible in the absence of a blowing agent. Accordingly, the invention provides a method of obtaining hollow filaments with exceptionally high aspect ratios.

Furthermore, in this embodiment the density is further reduced by the absence of a core. Accordingly, in preferred embodiments the hollow fiber according to the invention has a density of between about 0.3 and 0.7 g/cm³ with a density of between about 0.45 and 0.55 g/cm³ most preferred.

As in certain of the other embodiments, a preferred thermoplastic polymer is a polyester including polyethylene glycol present in the amount of between about six and 10% by weight, the submicron sized particles of fluorocarbon polymer in an amount not exceeding 2% by weight, a void fraction of at least about 50% by volume in the sheath, and the potential for use in fabrics selected from the group consisting of woven fabrics, nonwoven fabrics, and knitted fabrics.

Method Aspects of the Invention

The invention also includes the method of forming the various foamed fibers described herein. In this regard, there are a number of controlling factors that produce the desired fibers and their given surface and cell size characteristics.

Without being bound by theory, it is believed that key requirements to extrude foams with small and uniform cells include the near-simultaneous nucleation of a large number of bubbles in the melt, followed by rapid cooling to control the expansion and coalescence of the individual cells.

A high density of bubbles requires a high density of potential nucleating sites, which is aided by seeding the thermoplastic melt with a high density of well-separated nucleant particles possessing favorable surface characteristics for the initiation and growth of gas bubbles, when the imposed melt pressure falls below the vapor pressure of the dissolved blowing agents. These favorable particle characteristics include poor wetting with respect to the thermoplastic polymer melt and the existence of micro-crevices on the particle surface which can harbor trapped gases.

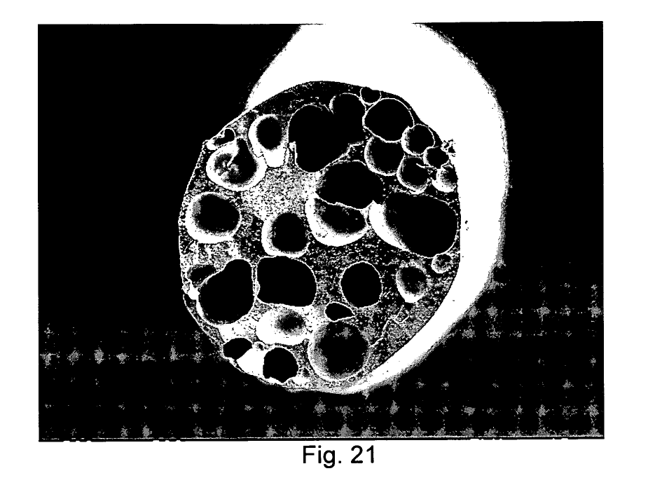

Near-simultaneous nucleation on all or most of these sites is enhanced by a rapid decompression of the melt, wherein the imposed pressure falls below the vapor pressure of the dissolved gases within a time scale that is small in relation to the expansion rate of the bubbles. If nucleation is too slow, then the earliest-forming bubbles will grow large before later ones can nucleate, and further nucleation will be inhibited by depletion of the surroundings of dissolved gases that diffuse into the growing bubble. FIGS. 20 and 21 illustrate this factor. In FIG. 20, the pressure drop rate is 3×10⁶ psi (pounds per square inch) per second and the resulting foam favorably exhibits greatar than fifty percent (50%) void fraction. In FIG. 21, the smaller pressure drop rate of 1.3×10⁶ psi/second produces a foam with less than thirty percent (30%) void rate.

The growth rate of the bubbles can be very rapid, reaching target sizes within a few milliseconds. The achievement of uniform bubble sizes breaks down into two areas of control; 1) slowing the growth rate of the bubbles, once nucleated, and 2) ensuring a fast decompression to generate a large thermodynamic instability of the polymer/gas solution.

The bubble growth rate is inhibited by viscous resistance of the polymer, which is favored by high melt viscosity, and also by elastic forces that develop near the surface of the bubble under rapid strain. These types of forces are controlled by the nature of the polymer, e.g. molecular weight and degree of cross-linking, as well as by the temperature of the melt. It is also influenced by the presence of the dissolved gases that can lubricate the polymer. Bubble growth rate is also influenced by the diffusion rate of the gas through the polymer into the growing bubble; diffusion is affected by the molecular size of the gas, its interaction with the polymer molecules, the concentration of gas in the melt, and the melt temperature. It can be of benefit to include small amounts of mobile gases that generate high initial vapor pressure to ensure rapid bubble nucleation, but become depleted before bubbles have become too large.

The decompression of the polymer occurs during the flow of the melt through the die into the atmosphere, during which elongation and shearing of the fluid elements converts the pressure energy into heat. To ensure that this pressure drop occurs rapidly with respect to the bubble growth time, it is beneficial to use small, short openings so that a fluid element experiences very high shear rates for a very brief period of time. Elastic polymer effects can also be beneficial, by generating melt tensions during flow elongation and during shearing flow near the particle interfaces; these elastic tensions act to counter the pressure forces and thus encourage nucleation.

The percentage of void volume is typically controlled by controlling the rate at which the blowing agent is added and the fiber (filament) wind up speed. A slower winding speed will produce a higher percentage of void volume while a faster wind up speed will produce a smaller percentage of void volume. The control and adjustment of wind up speed is well understood in this art and will not be discussed in detail herein, it being recognized that those of skill in this art can make the relevant adjustments without undue experimentation.

An appropriate manner of adding blowing agent is described in previously mentioned U.S. Pat. No. 6,051,174; i.e. by pressurizing the blowing agent (which is typically a gas at room temperature and atmospheric pressure) and then metering it into the extruder containing the polymer (or copolymer melt). Particular techniques or equipment for adding a gas to an extruder can be selected or adjusted by those of ordinary skill in this art and without undue experimentation and thus will not be discussed in detail herein.

The term “bubble” is also used herein in a sense identical to the term “cell,” or “void” with the proviso that “bubble” more frequently refers to cells in the polymer when the polymer is in the liquid state.

The bubble size and frequency (referred to earlier as cells per axial cross section) can also be controlled by controlling the nucleating agent and the extrusion conditions. Although the preferred nucleating agent is a fluorocarbon polymer as previously described herein, other nucleating agents can be used provided that they are incompatible with the polymer; i.e., in order to help generate cells the nucleating agent must avoid adhesion to the polymer and must form a second phase when mixed with the polymer. Similarly, the characteristics of the nucleating agent must be such that it avoids otherwise interfering with the spinning process.

The resulting foamed fibers can be produced with either closed cells or open cells, or in some cases both. This can likewise be controlled depending upon the rate of blowing agent addition, and the control of the bubble size.

The production of the surface effects described herein (smooth, fibrillated, channeled, pitted) is controlled by the bubble size and frequency and the total stretch ratio of both spinning and drawing. A smooth surface can be produced by producing small bubbles at a low stretch. A pitted surface is produced by generating large bubbles at a low stretch. Fibrillation or striated surfaces are produced from small bubbles and high stretch, while a channeled surface is produced by large bubbles and a high stretch. The degree of fibrillation can be controlled by controlling the bubble size and the spinning stretch ratio.

Given the variety of denier sizes and cell (bubble) sizes that can be selected, it will be understood that a wide variety of surface effects can be produced using the method of the invention.

In preferred embodiments, it has been found that retention of the blowing agent and cell formation is difficult at a spun denier per filament less than about 15. High void percentage fibers have a large outside diameter at a high denier per filament level. These factors tend to make deniers of between about two and 15 most preferred.

As stated earlier, the percentage of void volume can be controlled using several factors. At high void percentages, the resulting fibers will be necessarily weaker and prone to crush or other mechanical collapse. Furthermore, internal processing can become difficult at high percentage weight volume as is efficient packaging. Higher void fibers are more difficult to crimp in conventional processes such as a stuffer box. In present embodiments, these disadvantages seem to become most pronounced at void volumes of about 75% or greater, while void volumes of about 50% appeared to offer most or all of the desired advantages while avoiding the mentioned disadvantages.

In order to obtain open cells, the percentage of void volume typically needs to be higher than is required for closed cells. Generally, this appears to be a result of high void requiring correspondingly thin walls in the cell.

In some circumstances, the fibers (or filaments) of the invention are desirably heat set. Typical purposes for heat setting include fixing textured fibers in the textured configuration, establishing dimensional stability and improving dye fastness.

In optimizing heat set properties, the void volume of the foamed fibers tend to impart insulating properties. As a result, fibers according to the invention tend to absorb and retain heat less efficiently than conventional fibers in a heat set process. Nevertheless, the steps and processes for heat setting of polyester (and related) filament are such that those persons of ordinary skill in this art can design and adjust the steps as necessary or desired without undue experimentation.

With respect to crimping, foamed fiber tends to behave most similarly to conventional hollow cross sectional filament and will tend to have a natural spiral crimp if a differential orientation is present. Stuffer box crimping can be used, but can tend to collapse the fiber and reduce the percentage of void space. This can, however, be an appropriate trade off in some circumstances.

In one method embodiment, the invention comprises the step of dissolving an inert blowing agent, in an amount sufficient to generate at least about 50% void fraction in resulting spun filaments, in a liquid state polyester copolymer to form a solution, rather than a mixture or suspension, of the blowing agent in the copolymer. Stated differently, the blowing agent is soluble in the copolymer. Thus, a preferred blowing agent is soluble in polyester (and related copolymers) at temperatures at which polyester is in the liquid state (usually above about 260° C.), but does not react chemically with polyester or the related copolymers used in the invention. Having such characteristics, the blowing agent will evaporate from the thermoplastic polymer at lower temperatures or pressures (or both) and form the desired bubbles and cells. Fluorocarbon gases commercially available under the FREON trademark are considered suitable for use in accordance with the present invention, with FREON™ 134a (CF₃CH₂F) being a presently preferred and commercially available material.

It will thus be understood that the term “inert” as used with respect to the blowing agent defines a material different from those that are considered “inert” as nucleating agents. Those of ordinary skill in this art will recognize the difference and understand the two uses herein according to their context.

The method further comprises mixing the inert (as described previously) nucleating agent with the thermoplastic copolymer in an amount sufficient to increase the number of cells that the blowing agent will generate as compared to blowing agent alone under the same conditions, but less than an amount that adversely affects the spinning process. As noted earlier, this is typically no more than about 2 percent by weight with about 0.75 percent by weight being preferred. By way of example and not limitation, the top portion of FIG. 14 illustrates a finely foamed filament that will spin in satisfactory fashion.

The method further comprises adding the solution and the nucleating agent mixture in the liquid state to an extruder while maintaining the blowing agent in the solution. The mixture is next forwarded to a spinneret at a higher than normal polyester extrusion pressure to give extra shear and encourage expansion of the blowing agent as the filaments leave the spinneret. Finally, the method comprises spinning the mixture into filaments through the spinneret.

In the preferred embodiments, the method further comprises quenching the filaments in an otherwise conventional manner and thereafter taking up and drawing the filaments in a combined spin-drawing step. In addition to the other factors described earlier, a higher cooling rate at quenching tends to produce smaller cells because the solidification of the filaments proceeds more quickly.

As noted above, a sufficient pressure is maintained in the extruder to keep the dissolved blowing agent in solution at the temperature of the liquid thermoplastic polymer solution. Typically, the mixture is filtered prior to extrusion as is conventional for all sorts of filament production, and thus the step of forwarding the mixture at higher than normal pressure can comprise filtering the mixture at a higher than normal pressure and then passing it to the spinneret.

The use of a higher than normal pressure (i.e., higher than would be used to extrude a non-foamed thermoplastic polymer otherwise having the same composition) provides a greater pressure drop following extrusion and this helps encourage the development of a desirable, uniform foam.

The blowing agent is preferably dissolved in an amount of between about 0.1 and 5% by weight based on the weight of the copolymer, and most preferably in an amount of between about 0.5 and 1.5% by weight based on the weight of the thermoplastic polymer.

Without being bound by theory, it has now been discovered that adding blowing agent in a concentration of between about 0.25 and 2% (based on the weight of the thermoplastic polymer) is an exemplary concentration to produce the present foamed fibers. In some exemplary embodiments, a blowing agent concentration of between about 0.4 and 0.8% may be preferred. Stated functionally, the blowing agent concentration should be sufficient to produce a void fraction in the resultant foamed fibers of at least about 35%.

In preferred embodiments, the method includes a master batch technique for mixing the nucleating agent with the thermoplastic polymer. In this embodiment, the method comprises preparing a master batch of the nucleating agent and the thermoplastic polymer with the nucleating agent present in a higher proportion than desired for extrusion, and thereafter mixing the master batch with an additional amount of the thermoplastic polymer until the concentration of nucleating agent in the thermoplastic polymer reaches the extrusion amount. In the preferred embodiments, the method comprises preparing a master batch of submicron particles of fluorinated hydrocarbon polymer as the nucleating agent with a copolymer of polyethylene terephthalate and polyethylene glycol. Preferably, the method comprises preparing a master batch that is about 10% by weight of nucleating agent and thereafter mixing 1 part of the master batch with between about 4 and 19 parts of the thermoplastic polymer.

In an alternative aspect of this embodiment, the step of mixing the nucleating agent with the thermoplastic polymer can comprise mixing a nucleating agent in the solid-state with polymer chips. Thereafter, the polymer chips can be melted for the purpose of the extrusion and blowing agent solution steps. Furthermore, it is expected that the inert nucleating agent can be included in an otherwise conventional continuous polymerization process.

In embodiments where the extruded filaments are spun-drawn, the method can further comprise heat setting the filament. In the more preferred embodiments, the method comprises spin-drawing the filament at a ratio of between about 5:1 and 400:1 and drawing the filament over at least two sets of draw rolls, and potentially three or more sets.

In order to produce the self crimping filament described above, the method can comprise preferentially directionally quenching the spun filaments to thereby develop different degrees of orientation across the filaments that produce self crimping when the preferentially quenched filaments are heat set.

In another embodiment, the method comprises mixing a fluorocarbon polymer nucleating agent with a copolymer of polyester and polyethylene glycol in an amount of between about 0.5 and 1.5% by weight; dissolving a fluorocarbon polymer blowing agent in its liquid state in the copolymer portion of the mixture to form a solution of the blowing agent in the copolymer; and adding the solution and the nucleating agent mixture in the liquid state of the blowing agent at the extrusion temperature in the melted copolymer to thereby produce smaller cells and a more uniform cross section in the foam fiber.

In this embodiment, the method can comprise filtering the mixture at a higher than normal extrusion pressure (as compared to conventional polyester extrusion) to give extra shear and encourage expansion of the blowing agent as the filaments leave the spinneret.

Preferably the nucleating agent and blowing agent are respectively mixed and dissolved in a polymer blend, for example a polymer blend including a copolymer in which the polyethylene glycol is present in an amount of between about six and 10% by weight.

As in the previous embodiment, the step of mixing the nucleating agent with the polyester copolymer can comprise mixing the nucleating agent in the solid-state with polymer chips and thereafter melting the mixture, both prior to the step of dissolving the blowing agent.

As in the previous embodiment, the method can include a heat setting step.

The Figures included herein illustrate a number of the factors disclosed and claimed.

FIG. 1 illustrates a portion taken longitudinally of a filament as spun. The as-spun condition is generally (although not necessarily or exclusively) indicated by the small and non-elongated nature of the open cells that are visible on the surface. FIG. 1 illustrates a filament that is generally circular in cross-section, this being confirmed by the generally similar shade of gray across the photograph. As indicated by the cells in FIG. 1 and other structural features in other of the photographs, “deeper” portions tend to show up as dark portions in the SEM images. FIG. 1 is taken at a magnification of 20 and the relative size of the filament is indicated by the 2 mm bar.

FIG. 2 is an SEM image taken at a magnification of 100 of a set of filaments according to the present invention that have been drawn to produce a channeled surface. The spin-drawing step described herein tends to produce such channels by concurrently elongating both the filament and its corresponding cells. Stated differently, the relatively small almost circular cells illustrated in FIG. 1 become, when the filament is drawn, the long channels that are illustrated as the lighter and darker longitudinal portions along the filaments illustrated in FIG. 2.

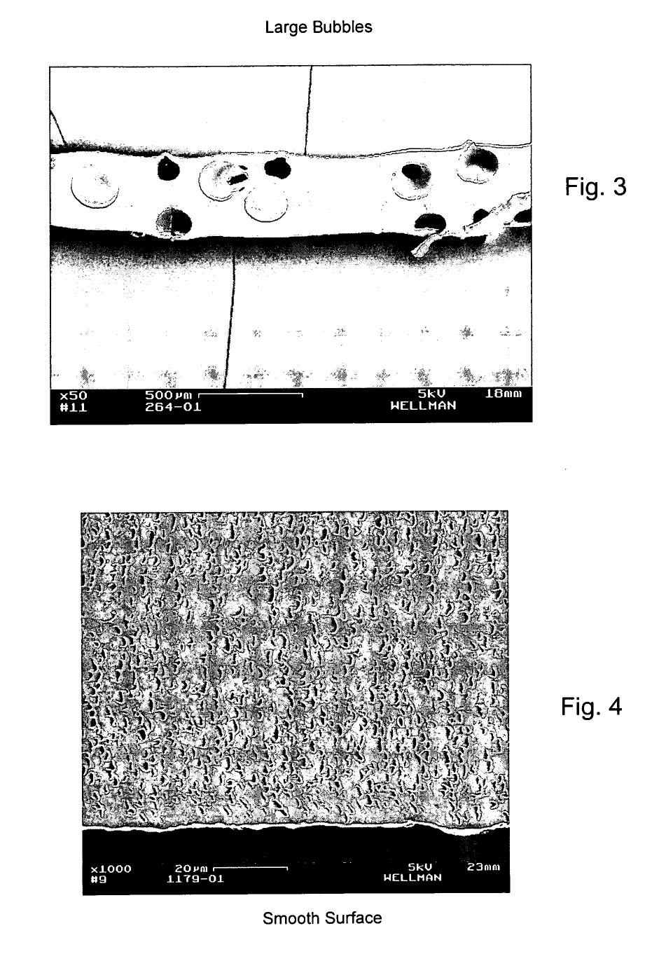

FIG. 3 illustrates a longitudinal cross-section of a filament according to the present invention taken in the magnification of about 50. As set forth herein, such larger bubbles, when desired, are produced by reducing or eliminating the nucleating agent, minimizing or avoiding quench, and minimizing or avoiding a drawing step.

FIG. 4 is included for comparison purposes and illustrates a cross sectional view taken at a magnification of 1000 of a finely-foamed cast polymer rather than a fiber or filament. FIG. 4 illustrates the capability according to the invention of producing extremely small cells within the polymer, and particularly within the copolymer of polyester with polyethylene glycol.

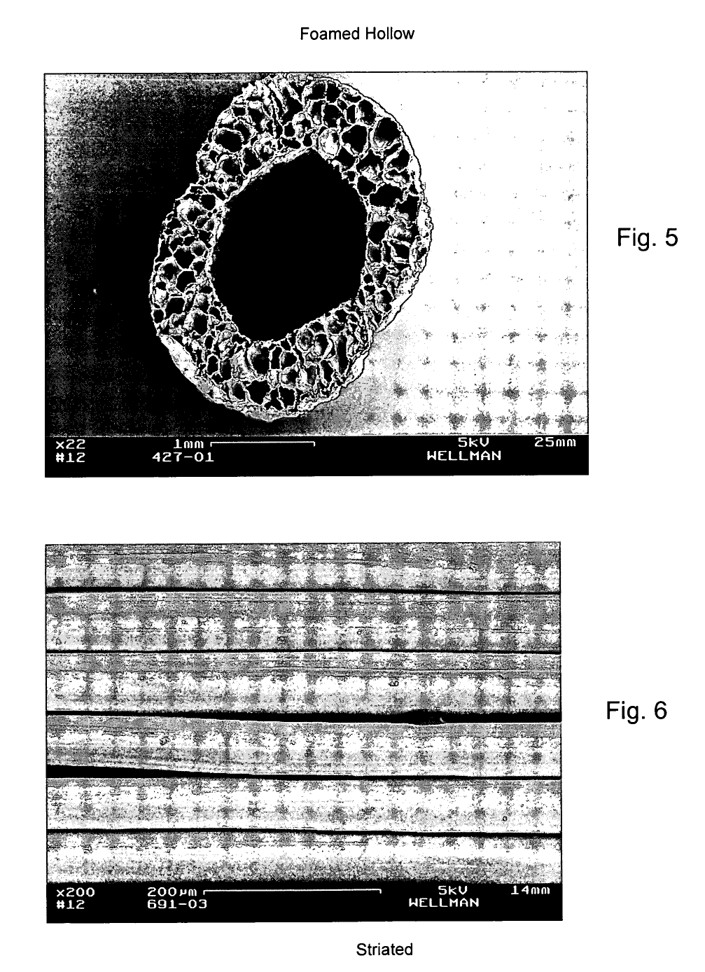

FIG. 5 is an SEM image taken at a magnification of 22 of a foamed hollow filament (cross section). As set forth herein, the structure offers a particular advantage for extremely low density applications. First, the large hollow portion lowers the density in comparison to solid filaments independently of the foamed structure. In the case of the invention, however, the foamed sheath further reduces the density as compared to a solid sheath in a more conventional hollow film.

FIG. 6 is an SEM image taken at a magnification of 200 of a plurality of filaments that include a fibrillated or striated surface. As described previously, these filaments are produced by extruding the foamed filaments with layer cells and then drawing them at relatively high stretch. Such striated filaments offer particular advantages in applications where extremely small fiber properties (e.g., the fibrils) are desired or necessary.

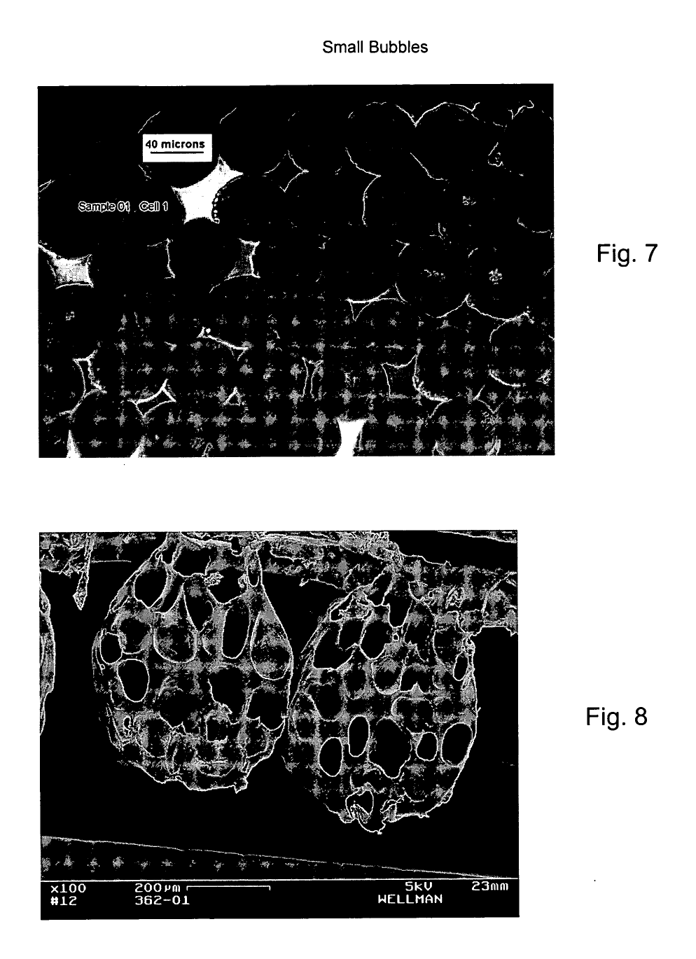

FIG. 7 is a view of a plurality of fibers according to the invention taken cross-sectionally rather than longitudinally with a 40 micron scale included to help indicate the size. FIG. 7 illustrates that the invention can provide a large number of small bubbles in the resulting foamed fibers. As set forth earlier, for any given functional void volume, a larger number of smaller cells will tend, in most circumstances, to provide greater structural stability to the filaments.

FIG. 8 is another cross-sectional view of foamed filaments according to the present invention.

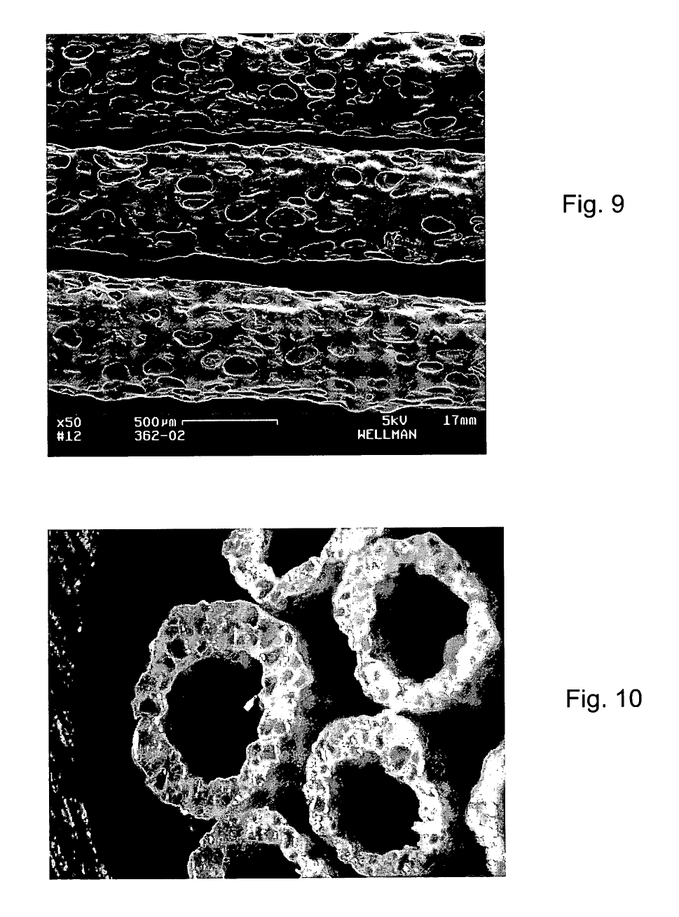

FIG. 9 is a photograph taken at a magnification of 50 showing the filaments in a slightly drawn condition as indicated by the somewhat oval nature of the open cells, but which have not yet been drawn into channels or fibrils.

FIG. 10 is another cross-sectional view of hollow core foamed filaments according to the present invention.

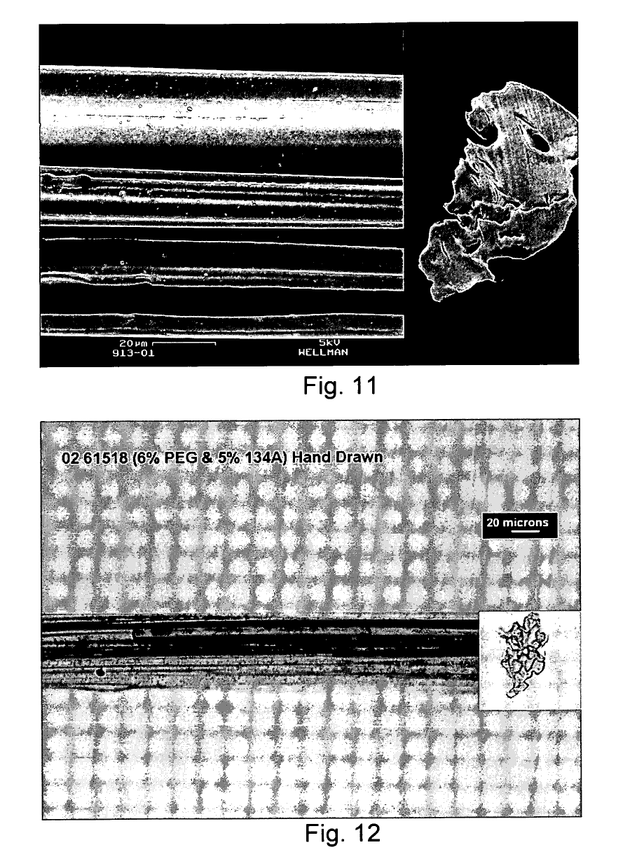

FIG. 11 is a combination of two SEM images that are presented together for purposes of illustration. The left-hand portion is a longitudinal view of two filaments that have been drawn as indicated by the fact that large longitudinal channels are visible rather than cells. The right hand portion of FIG. 11 is a cross-sectional view taken from among the same set of samples as the left-hand portion. The right hand portion should not, however, be understood as necessarily being the exact cross-section of the left-hand portion. The right hand portion of FIG. 11 illustrates the potential for producing highly irregular cross-sections which in turn indicate the presence of highly irregular surface effects, yet in a structurally sound low density fiber or filaments. As noted elsewhere herein, the surface effects can be particularly valuable in fluid absorption and take up capabilities.

FIG. 12 is a combination of two optical micro-photographs according to the present invention which are again superimposed for illustration purposes. FIG. 12 also illustrates the presence of long channels and a favorably unusual and irregular cross-sections.

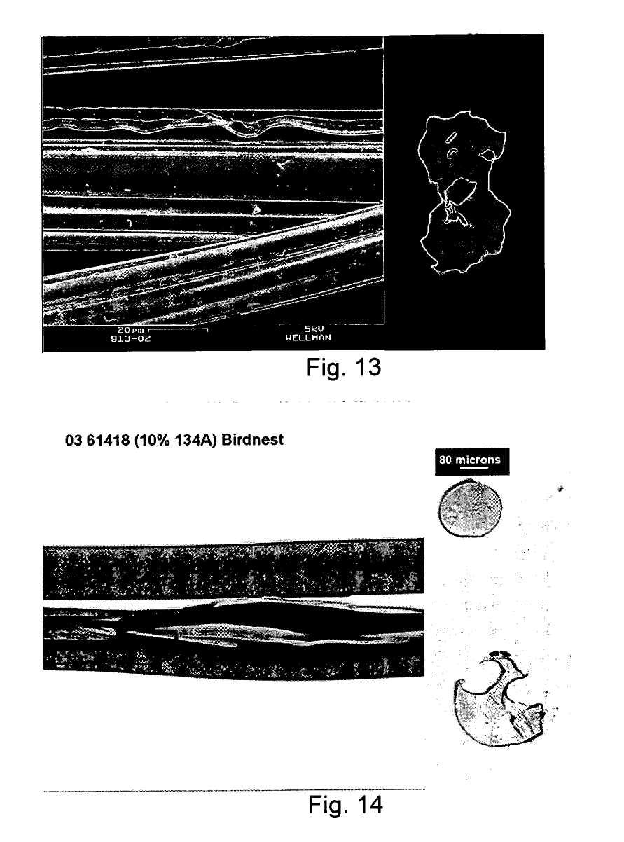

FIG. 13 is another combination of two SEM images showing in particular extensive longitudinal channels in the left-hand portion, and a favorably unconventional cross-section in the right hand section.

FIG. 14 is another composite illustration made from optical micro-photographs of two fibers taken longitudinally and two taken in cross-section. The upper filament in FIG. 14 is finely foamed with a solid exterior as illustrated by its cross-section in the right hand portion. The lower filament in FIG. 14 has a series of extensive channels as further illustrated by its cross-section in the lower right hand portion of FIG. 14.

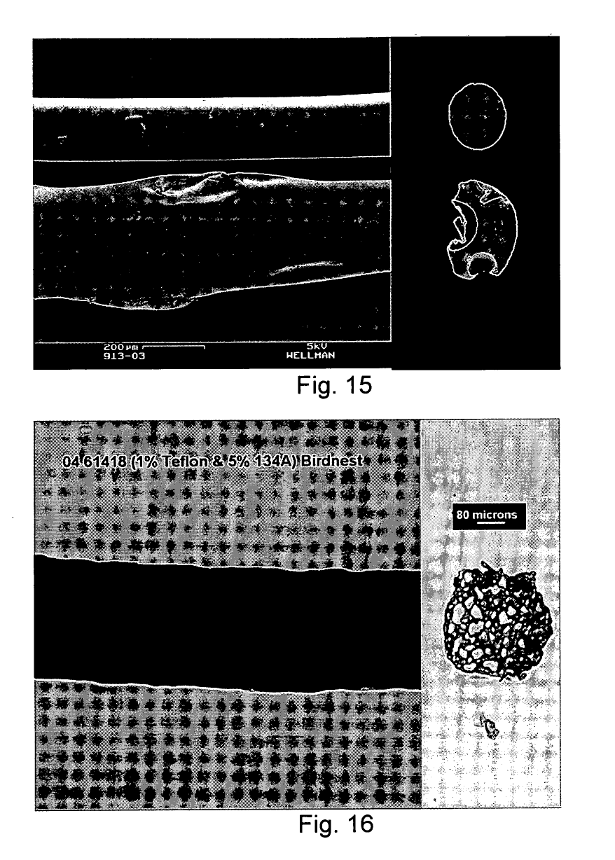

FIG. 15 is another comparison composite SEM image, the left-hand portion of which is a longitudinal side-by-side view of two filaments, the upper one a conventional solid filament and the lower one a foamed filament, including large bubbles, according to the present invention. The regular cross-section of the conventional filaments and the favorably irregular and unusual cross-section of the lower filaments are respectively illustrated in the right hand portion of FIG. 15.

FIG. 16 is another composite made from two optical images, the left-hand portion of which illustrates filaments as extruded, with a significantly foamed cross-section shown in the right hand portion. In particular, the right hand portion of FIG. 16 shows the favorably high number of cells that can be formed using the present invention.

FIG. 17 is another composite of two SEM images, the left-hand portion of which illustrates two as-spun filaments in side-by-side relationship and the right hand portion of which illustrates a cross-section of a portion of such filaments. Again, the right hand portion of FIG. 17 does not necessarily represent the cross-section of the exact portions shown in the left-hand portion of FIG. 17, but is taken from the same representative set of filaments. FIG. 17 again illustrates the favorably high number of cells that can be formed in cross-section in the as-spun filaments.

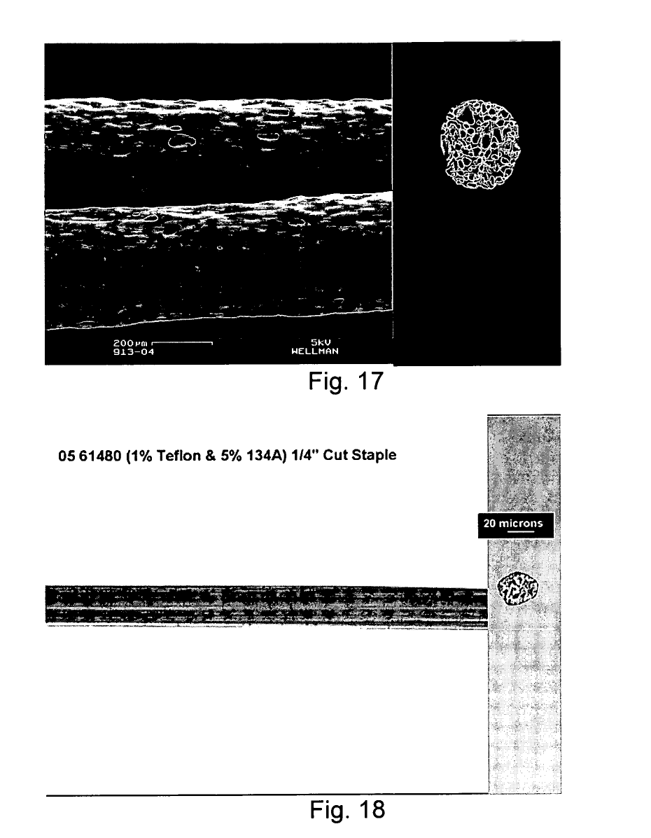

FIG. 18 is another composite micro-photograph of one filament according to the present invention drawn to produce a number of channels which appear in FIG. 18 as the various lines in different shades of gray (and in some cases white) in the left-hand portion of FIG. 18. The right hand portion of FIG. 18 is yet another cross-section illustrating the large number of cells produced by the method of the invention and present in the foamed filaments according to the invention.

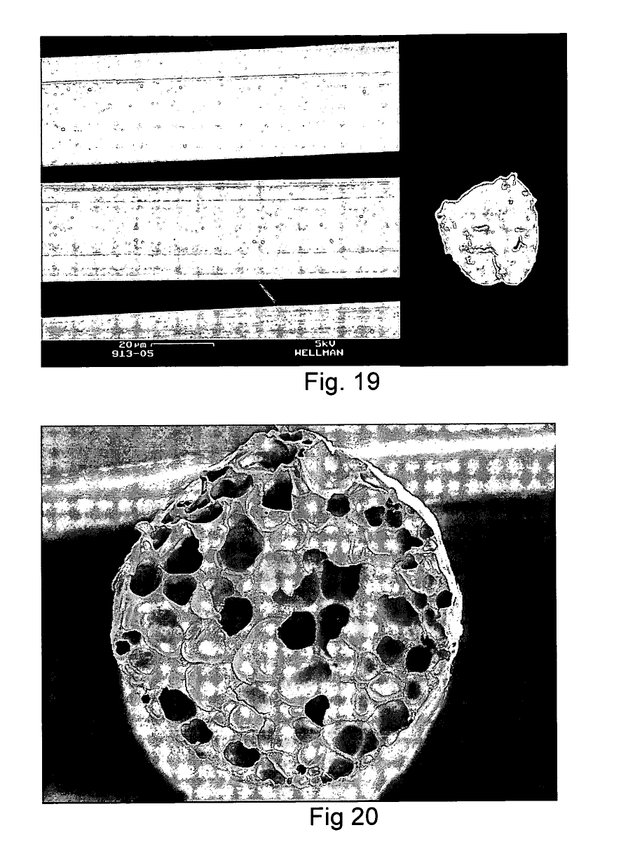

FIG. 19 is another composite of two SEM images in which the left-hand portion illustrates a number of filaments with a channel surface formed by drawing the as-extruded foamed filaments. The right hand portion is an illustrative cross-section taken from the same group of samples, but not necessarily directly across the samples illustrated in the left-hand portion of FIG. 19.

The invention accordingly provides a number of advantages. These include porous fibers of denier of between about two and 15, significantly lower density than standard thermoplastic polymer fibers, high void percentages, potentially fibrillated surfaces, engineered surface treatments, engineered porous characteristics, smooth or porous surfaces, cut lengths for air laid or carding techniques, and the use of copolymers. Potential applications include absorbent core structures with high structural integrity (see, e.g. commonly assigned and co-pending application Ser. No. 10/250,191), synthetic fluff pulp, air or fluid filtration, sound insulation, thermal insulation, fiberfill applications, fiber matrix reinforcement, substrates for delivering other materials, fiber structures that will hold other resins, technology applicable to other polymers or processes, medical gauze, wipe products, light abrasives, and medical padding.

As a replacement for fluff pulp, the invention offers considerable advantages in spite of the potential price difference. For example, current prices for fluff pulp are between about $0.35 per pound for untreated fluff pulp and $0.50 per pound for treated fluff pulp. Although the comparative price for microporous polyester is expected to be about one dollar per pound, the desired bulk density of the microporous polyester can be achieved by using about 33% of the equivalent amount of fluff pulp. As a result, the functional price of fibers according to the invention (i.e., the cost of obtaining an equivalent structure or performance) is about $0.35 per equivalent pound. Furthermore, the microporous polyester offers a number of functional advantages. It reduces collapse, whether from wetting or from packaging, it reduces the total weight, it offers fluid movement with less absorption or distribution, and can form a good bond with a number of the bi-component fibers that are often used to bond such structures.

As an absorbent, polyester is generally soft with the PEG copolymer being significantly softer; the copolymer of polyester and polyethylene glycol is significantly more hydrophilic than standard polyester and rayon, the physical design of these fibers provide added absorbency and the hydrophilic nature of polyester improves fabric absorbency.

In another aspect, the invention is a process for melt extrusion of thermoplastic foam. In this aspect, the invention comprises extruding a molten mixture of an elastic thermoplastic polymer with a melt viscosity of the least about 1000 poise at extrusion temperature and a molecular relaxation time of at least about 0.001 seconds (1 millisecond).

In preferred embodiments the polymer is polyester, including copolymers, with copolymers of polyethylene terephthalate and polyethylene glycol being preferred.

The mixture being extruded contains an additive comprised of insoluble (with respect to the melt) particles that range in size from between about 50 and 500 nm and that are present in an amount of between about 0.1% and 1.0% by weight. The melt also contains a dissolved blowing agent in an amount sufficient to generate a gas pressure of between about 5 and 200 atmospheres at extrusion temperature, the mixture being extruded through a nozzle at a flow rate sufficient to generate a wall shear rate exceeding about 10,000 per second.

In somewhat more detail, the polymer preferably has a melt viscosity of between about 1000 and 20,000 poise at an extrusion temperature of between about 260 and 310° C. Viscosities below about 1000 will not support a stable foam, while viscosities higher than about 20,000 are unreasonably expensive for commercial purposes and have a significant loss of elasticity.

Temperatures of below about 260° C. result in viscosities that are generally too high for convenient extrusion, while temperatures above 310° C. tend to degrade polyester and lower the viscosity below useful limits.

The particles are preferably insoluble with respect to the polymer melt. Particles smaller than about 50 nm are unlikely to initiate or sustain nucleation. Without being bound by theory, it appears that particles larger than about 20 microns (μm) physically interfere with the spinning process and the resulting fibers. In general, all other factors being equal, smaller particles are better than larger ones consistent with the above limitations.

At least about 0.1% by weight of particles is required to initiate bubbles. Amounts greater than about 1% by weight may, however, tend to physically interfere with the process and the resulting fibers.

As used herein with respect to the blowing agent, the term “dissolved” refers to the blowing agent being soluble in the thermoplastic polymer melt.

With respect to the gas pressure, it should be understood that in extrusion equipment and processes, the gas does not behave consistently with the ideal gas law, but rather is under supercritical conditions and behaves in that manner. The pressure has to be high enough for the gas to leave the melt as the melt enters and then exits the spinneret hole(s). An overly high pressure, however, simply pushes the polymer into pieces without generating small bubbles. The gas pressure also must be lower than the pressure at which the thermoplastic polymer is being extruded. In that regard, those familiar with polyester manufacturing processes will recognize that an extrusion pressure of about 1000 lbs. per square inch (psi) is normal, 3000 psi is relatively high, and 500 psi is relatively low.

The desired flow rate depends on the throughput and the diameter of the hole.

Those familiar with variables in polymer production will understand that some variables can be proactively controlled while other variables will follow from the controlled ones. Accordingly, in carrying out the invention the factors or variables that can be controlled include the temperature range, the choice and composition of the polymer, the intrinsic viscosity, the melt viscosity, the denier (based on throughput per hole and wind up speed), the hole size, the type and amount of nucleating agent, and the type and amount of blowing agent.

In turn, the throughput per hole dictates the pumping pressure, and as noted above, the pressure of the blowing agent must exceed the pumping pressure in order to bubble and generate foam.

The gas pressure and pumping pressure are in equilibrium with each other through the flow path. When the polymer/gas solution reaches a pressure less than that which can keep the gas in solution, the gas starts evolving and bubbles start to form. The goal is to run the process so this starts to happen in the spinneret capillary. Preferably the gas evolution should be at a location where high shear is present so that the nucleating particles can “tear” the polymer creating small openings for the gas to enter. The highest process shear is in the spinneret capillary.

Thus, it will be understood that prior to the spinneret hole, the polymer is under the pumping pressure, while at the exit from the spinneret whole, the polyester is at atmospheric pressure. A linear pressure drop exists from the pumping pressure to atmospheric pressure through the spinneret hole. The goal is to avoid generating bubbles at pumping pressure but instead to have bubbles form as the pressure drops from the pumping pressure to the atmospheric pressure as the polyester moves through and exits the spinneret whole.

Using the method, the resulting product can be expressed as foamed thermoplastic fibers containing elongated voids in which the smallest linear dimension of the article does not exceed half of a millimeter, the average cross-sectional diameter of the included voids does not exceed about 20% of the smallest linear dimension, the length of the voids is at least 2 times longer than the diameter, and the voids are present in a sufficient number to form at least about 10% of the total volume of the thermoplastic article. The 0.5 mm dimension refers to the smallest dimension of the article being foamed. This number applies to a dimension as if no foaming has been done. The foamed dimension is accordingly larger proportional to the void space created

In the drawings and specification there has been set forth a preferred embodiment of the invention, and although specific terms have been employed, they are used in a generic and descriptive sense only and not for purposes of limitation, the scope of the invention being defined in the claims.

1. A lightweight, low density fiber comprising:
at least one member of the group consisting of thermoplastic polymers and thermoplastic polymer blends;
more than thirty five percent functional void fraction in the form of foam-forming cells for reducing the density of the fiber as compared to a solid fiber;
at least five void cells per axial cross section for increasing the structural integrity of the fiber as compared to less uniform foams; and
a nucleating agent particle composition that is chemically inert with respect to said thermoplastic polymer blend, and is present in an amount less than 10 percent by weight.

2. A foamed fiber according to claim 1 wherein said inert nucleating agent is selected from the group consisting of fluorocarbon polymers, silicone, and combinations thereof.

3. A foamed fiber according to claim 1 wherein said inert nucleating agent is non-irradiated fluorocarbon polymers.

4. A foamed fiber according to claim 1 wherein about 90% of nucleating particles in said nucleating particle composition have a particle size less than about 20 μm.

5. A foamed fiber according to claim 1 wherein said nucleating agent has poor wettability with respect to a melt of said thermoplastic polymer blend.

6. A foamed fiber according to claim 1 having a denier of between about 2 and 15.

7. A foamed fiber according to claim 1 having between about 40 and 75% functional void fraction.

8. A foamed fiber according to claim 1 having between about 6 and 30 cells per cross section.

9. A foamed fiber according to claim 1 having a smooth surface.

10. A foamed fiber according to claim 1 having a fibrillated surface for increasing the moisture transfer capabilities of the fiber.

11. A foamed fiber according to claim 1 having a channeled surface.

12. A foamed fiber according to claim 1 having a pitted surface.

13. A foamed fiber according to claim 1 wherein said thermoplastic polymer blend comprises a thermoplastic polymer and at least one of the group consisting of copolymers, homopolymers, comonomers, and plasticizers.

14. A foamed fiber according to claim 1 wherein said thermoplastic blend comprises a thermoplastic polymer and between about 2 and about 10% by weight of at least one of the group consisting of copolymers, homopolymers, comonomers, and plasticizers.

15. A foamed fiber according to claim 1 having open and closed cells.

16. A fabric comprising fibers according to claim 1.

17. A foamed fiber according to claim 1 comprising between about 0.5 and 1.0 percent by weight of said nucleating agent particle composition.

18. A low density, light weight fiber according to claim 1 comprising a non-uniform surface for providing additional mechanical properties to the foamed fiber as compared to corresponding smooth surface fiber.

19. A fabric formed from the foamed fiber according to claim 18 and selected from the group consisting of woven fabrics, non-woven fabrics, filling materials and battings, absorbent cores, direct melt spun fabrics, and knitted fabrics.

20. A lightweight, low density foamed fiber consisting essentially of:
at least one member of the group consisting of thermoplastic polymers and thermoplastic polymer blends;
between about thirty-five and seventy five percent functional void fraction;
between about 6 and 30 cells per axial cross section; and
particles of polytetrafluoroethylene, present in an amount less than 10 percent by weight, and wherein the surface of said polytetrafluoroethylene particles is substantially free of acid groups.

21. A foamed fiber according to claim 20 having a density of between about 0.5 and 0.85 g/cm³.

22. A fabric comprising fibers according to claim 20 and selected from the group consisting of woven fabrics, knitted fabrics, filling materials and battings, absorbent cores, direct melt spun fabrics, and non-woven fabrics.

23. A method of producing a foamed fiber in a continuous technique, the method comprising:
mixing an inert nucleating agent with a thermoplastic polymer blend in an amount sufficient to increase the number of cells that the blowing agent will generate as compared to blowing agent alone under the same conditions, but less than an amount that adversely affects the spinning process;
melting and forwarding the polymer blend in an extruder into a zone where the melt polymer blend is under pressure
dissolving an inert blowing agent in an amount sufficient to generate at least about 35% void fraction in resulting spun filaments in its liquid state into the pressurized melt to form a solution of the blowing agent in the polymer blend;
forwarding the mixture to a spinneret at a higher than normal polyester extrusion pressure to give extra shear and encourage expansion of the blowing agent as the filaments leave the spinneret; and
spinning the mixture into filaments through the spinneret.

24. A method according to claim 23 further comprising:
quenching the filaments in an otherwise conventional manner; and
thereafter taking up and drawing the filaments.

25. A method according to claim 23 comprising maintaining a sufficient pressure in the extruder to keep the dissolved blowing agent in solution at the temperature of the liquid thermoplastic polymer solution.

26. A method according to claim 23 wherein the step of forwarding the mixture at higher than normal pressure comprises filtering the mixture at a higher than normal pressure.

27. A method according to claim 23 comprising dissolving the blowing agent in an amount of between about 0.25 and 2 percent by weight based on the weight of the thermoplastic polymer blend.

28. A method according to claim 23 comprising dissolving the blowing agent in an amount of between about 0.4 and 0.8 percent by weight based on the weight of the thermoplastic polymer blend.

29. A method according to claim 23 comprising dissolving a fluorinated hydrocarbon as the blowing agent.

30. A method according to claim 29 comprising dissolving CF₃CH₂F.

31. A method according to claim 23 wherein the step of mixing the nucleating agent with the thermoplastic polymer blend comprises:
preparing a masterbatch of the nucleating agent and the thermoplastic polymer blend with the nucleating agent present in a higher proportion than desired for extrusion; and
thereafter mixing the masterbatch with an additional amount of the thermoplastic polymer blend until the concentration of nucleating agent in the thermoplastic polymer blend reaches the extrusion amount.

32. A method according to claim 31 comprising preparing a masterbatch of nucleating particles selected from the group consisting of silicone and fluorinated hydrocarbon as the nucleating agent with a copolymer of polyethylene terephthalate and polyethylene glycol and at least one of an additional copolymer, homopolymer, comonomer and plasticizer as the thermoplastic polymer blend.

33. A method according to claim 31 comprising preparing a masterbatch that is about 10 percent by weight of nucleating agent and thereafter mixing one part of the masterbatch with between about 4 and 19 parts of the thermoplastic polymer blend.

34. A method according to claim 23 wherein the step of mixing the nucleating agent with the thermoplastic polymer blend comprises:
mixing a nucleating agent in the solid state with polymer chips; and
thereafter dissolving an inert blowing agent in a thermoplastic polymer blend melt.

35. A method according to claim 23 wherein the step of mixing the nucleating agent with the thermoplastic polymer blend comprises mixing a nucleating agent having micro-crevices on a surface of the nucleating agent that can harbor trapped gasses, thereby increasing the rate of nucleation.

36. A method according to claim 23 wherein the step of mixing the nucleating agent with the thermoplastic polymer blend comprises mixing a nucleating agent having poor wettability with respect to the thermoplastic polymer blend melt.

37. A method according to claim 23 comprising texturing the spun filaments.

38. A method of forming a low density filament according to claim 23 comprising spinning the mixture into hollow filaments through the spinneret by extruding the filaments as adjacent pairs of c-shaped filaments that join as they are passively or actively quenched to form a hollow filament with a sheath foamed by the blowing agent during the extrusion from the spinneret.

39. A method according to claim 38 comprising filtering the mixture at higher than normal extrusion pressure to give extra shear and encourage expansion of the blowing agent as the filaments leave the spinneret.

40. A self-crimping filament comprising:
a thermoplastic polymer blend;
at least about 35% void space by volume more than 5 cells per axial cross section; and
different degrees of orientation along at least two adjacent longitudinal portions of the filament.

41. A self-crimping filament according to claim 40 comprising between about 45 and 75% void space by volume.

42. A self-crimping filament according to claim 40 wherein said thermoplastic polymer blend comprises a polyester and between about 6 to 10 percent by weight of a member of the group consisting of copolymers, homopolymers, comonomers, and plasticizers.

43. A self-crimping filament according to claim 40 comprising between about 6 and 30 cells per axial cross section.

44. A self-crimping filament according to claim 40 comprising particles of a fluorocarbon polymer in an amount not exceeding about two percent by weight.

45. A self-crimping filament according to claim 40 having a denier of between about 2 and 15.

46. A self-crimping filament according to claim 40 having a density of between about 0.4 and 0.6 grams per cubic centimeter.

47. A fabric formed from the self-crimping filament according to claim 40 and selected from the group consisting of woven fabrics, non-woven fabrics, filling materials and battings, absorbent cores, direct melt spun fabrics, and knitted fabrics.

48. A low density light weight fiber comprising:
a thermoplastic polymer blend;
a hollow core for reducing the overall density of the fiber compared to a solid fiber; and
a foamed sheath for further reducing the overall density as compared to a solid-sheath hollow fiber.

49. A low density light weight fiber according to claim 48 wherein said thermoplastic polymer blend includes at least one of polyesters, polylactides, polyamides, polycarbonates, polyolefins, polyacrylics, comonomers, plasticizers, and combinations thereof.

50. A low density light weight fiber according to claim 48 comprising particles of a fluorocarbon polymer wherein about 90% of said particles have a diameter of less than about 20 μm and wherein said particles are present in an amount not exceeding two percent by weight.

51. A low density light weight fiber according to claim 48 wherein said foamed sheath has a void fraction of at least about 35 percent by volume.

52. A low density light weight fiber according to claim 48 having a density of between about 0.3 and 0.7 grams per cubic centimeter.

53. A low density light weight fiber according to claim 48 having a density of between about 0.45 and 0.55 grams per cubic centimeter.

54. A fabric formed from the fiber according to claim 48 and selected from the group consisting of woven fabrics, non-woven fabrics, filling materials and battings, absorbent cores, direct melt spun fabrics, and knitted fabrics.

55. A process for melt extrusion of thermoplastic foam comprising:
extruding a molten mixture of a thermoplastic polymer blend with a melt viscosity of at least about 1000 poise at extrusion temperature, and a molecular relaxation time of at least about 1 millisecond;
and containing an additive comprised of insoluble particles, wherein about 90% of the particles are between about 500 nanometers and about 20 μm, at an additive level from about 0.1% to about 1.0% by weight;
and containing a dissolved blowing agent in an amount between about 0.2% to about 2% by weight;
through a nozzle at a flow rate sufficient to generate a wall shear rate exceeding 10,000 per second at a pressure drop rate of at least about 100,000 psi per second.

56. A melt extrusion process according to claim 55 comprising extruding a polymer blend with a melt viscosity of between about 1000 and 20,000 poise.

57. A melt extrusion process according to claim 55 comprising extruding a polymer at an extrusion temperature of between about 260 and 310° C.

58. A melt extrusion process according to claim 55 comprising extruding polyester as one component of the thermoplastic polymer blend.

59. A melt extrusion process according to claim 55 comprising extruding a copolymer of polyester and polyethylene glycol, with the polyethylene glycol being present in an amount of between about 6 and 10 percent by weight of the copolymer as one component of the polymer blend.

60. A melt extrusion process according to claim 58, comprising extruding at least one member of the group consisting of copolymers, homopolymers, comonomers, and plasticizers as another component of the thermoplastic polymer blend.

61. A melt extrusion process according to claim 55 comprising extruding a mixture in which the insoluble particles are selected from the group consisting of silicone and polytetrafluoroethylene.

62. A melt extrusion process according to claim 55 further comprising:
quenching the filaments in an otherwise conventional manner; and
thereafter taking up and drawing the filaments.

63. A melt extrusion process according to claim 62 comprising a post-quench draw-down ratio greater than 100:1.

64. A melt extrusion process according to claim 62 wherein extrusion pressure is at least about 500 psig.

65. A melt extrusion process according to claim 56 wherein the blowing agent comprises CF₃CH₂F (HFC134a).

66. A melt extrusion process according to claim 55 comprising extruding the mixture at a pump pressure of between about 500 and 3000 psi.

67. A melt extrusion process according to claim 55 comprising extruding a mixture in which the intrinsic viscosity of the polymer blend is less than 0.7.
